(19) United States
(12) Patent Application Publication
(10) Pub. No.: US 2010/0156188 A1
(43) Pub. Date: Jun. 24, 2010

(54) Solar Photovoltaic Power Collection via High Voltage, Direct Current Systems with Conversion and Supply to an Alternating Current Transmission Network

(76) Inventor: Oleg S. Fishman, Maple Glen, PA (US)

Correspondence Address: OLEG S FISHMAN, 1 SALJON COURT, MAPLE GLEN, PA, 19002, US

(21) Appl. No.: 12/434,641

(22) Filed: May 2, 2009

Related U.S. Application Data
(60) Provisional application No. 61/140,839, filed on Dec. 24, 2008.

(51) Int. Cl. H02M 7/42; H02J 3/00

(52) U.S. Cl. 307/77; 307/82

(57) ABSTRACT

Solar photovoltaic power is collected in a multiple nodal arrangement where the DC output voltage of each node is held constant while the DC current is allowed to vary based upon the maximum power point of the solar cells making up the solar power collectors in each node. The output of each solar power collection node is regulated by a node-isolated step-down current regulator that maintains a constant DC current output while the DC output voltage is allowed to vary. The outputs of all node-isolated step-down current regulators are connected together in series and fed to a plurality of regulated current source inverters that each convert input DC power into a three phase AC output. The AC outputs of the regulated current source inverters are connected to a phase shifting transformation network that supplies three phase electric power to a conventional AC electrical transmission system.

### CROSS-REFERENCE TO RELATED APPLICATIONS

This application claims the benefit of U.S. Provisional Application No. 61/140,839, filed Dec. 24, 2008, hereby incorporated by reference in its entirety.

### FIELD OF THE INVENTION

The present invention relates to the collection of solar photovoltaic (PV) power via a high voltage (HV) direct current (DC) system, conversion of the DC power into alternating current (AC) power, and supply of the AC power to an electric power transmission network.

### BACKGROUND OF THE INVENTION

Typically megawatt and larger capacity solar photovoltaic (PV) power plants comprise a large number of solar PV power collectors, such as solar PV modules, that supply DC electric power to collocated DC to AC inverters, which convert the DC power into AC electric power. The term “solar farm” is sometimes used to describe the large number of solar PV power collectors and inverters that can be used to collect solar photovoltaic power. The inverted AC electric power is typically injected into an electric power transmission network (grid) that is located within a few miles from the AC outputs of the inverters. For example with reference to FIG. 1, multiple strings 901 of PV solar cells formed from a plurality of serially connected solar photovoltaic modules 902 are interconnected in parallel to form solar farm 904 to provide a low DC voltage (nominally less than 1,000 volts) input to AC-to-DC inverters 906 that output low AC voltage (nominally in the range of 300 to 600 volts). The inverters' output voltages are transformed to at least medium AC voltage (nominally in the range of 13.4 to 39.4 kilovolts) and supplied to transmission transformer 908 that raises the voltage to the high voltage range (nominally from 169 to 345 kilovolts) for interconnection to an AC transmission network 122 or “grid.”

A disadvantage of the above conventional solar farm is that the large number of solar PV power collectors needed to collect a megawatt or greater quantity of DC electric power requires a significant contiguous area for mounting of the collectors. This area can extend for many acres. Consequently sighting constraints for a typical megawatt or larger solar farm is a large contiguous area that is not far from the AC grid into which the converted DC power is to be injected.

One object of the present invention is to provide an arrangement of apparatus for, and method of, efficiently collecting solar photovoltaic DC electric power from multiple groups of solar PV power collectors that are not required to be collocated with each other, or with the inverters that convert the DC electric power into AC power for injection into an electric power transmission network.

### BRIEF SUMMARY OF THE INVENTION

In one aspect the present invention is apparatus for collecting at least one megawatt of solar photovoltaic power and delivering the at least one megawatt of solar photovoltaic power to an AC transmission network. At least one high voltage DC source is provided for generating the at least one megawatt of solar photovoltaic power. The DC source has a high voltage DC source output voltage rating of at least 1.5 kilovolts. A high voltage DC power transmission link is provided for connection to the high voltage DC source output. At least one DC to AC inverter is provided. Each DC to AC inverter has an inverter DC input connected to the high voltage DC source output via the high voltage DC power transmission link, and an inverter AC output for injection of the at least one megawatt of solar photovoltaic power into the AC transmission network. Each high voltage DC source may comprise one or more nodes of solar photovoltaic power collectors with each of the nodes having an output connected to the input of a dedicated node isolated step-down current regulator, and the outputs of all dedicated node isolated step-down current regulators serially interconnected to form a serial string DC current circuit. The solar photovoltaic power collectors for each node can be arranged in one or more groups of solar photovoltaic power collectors with each group of solar photovoltaic power collectors having a group output interconnected in parallel to the output of the dedicated node isolated step-down current regulator. Each group of solar photovoltaic power collectors may comprise a plurality of solar photovoltaic modules interconnected in a series string circuit connected to the input of a step-up voltage regulator. The high voltage DC power transmission link may comprise a DC transmission line, underground cable or submarine cable traversing a minimum distance of 500 meters, or a combination of a DC transmission line and an underground cable traversing at least a distance of 500 meters. Each DC to AC inverter may comprise at least one regulated current source grid synchronized inverter where the inverter AC output has a three phase substantially stepped current waveform. Alternatively the at least one DC to AC inverter may comprise a plurality of regulated current source grid synchronized inverters with the inverter DC inputs of the plurality of regulated current source grid synchronized inverters serially interconnected to form an inverter input series string circuit that is connected to the high voltage DC power transmission link, and with the inverter AC output of each of the regulated current source grid synchronized inverters having a three phase substantially stepped current waveform. The inverter AC output of each regulated current source grid synchronized inverter may be connected to the AC transmission network via a phase shifting transformation network. The phase shifting transformation network may comprise one or more transformers with each transformer having multiple secondary phase shifting windings connected to the inverter AC outputs of one or more of the plurality of regulated current source grid synchronized inverters, and multiple primary phase shifting windings connect to the AC transmission network. A control system comprising a plurality of distributed devices may be provided. The control system can determine and set the voltage regulation duty cycle for each one of the step-up voltage regulators for the maximum power point of each group of solar photovoltaic power collectors. The control system can also determine and set the current regulation duty cycle for each dedicated node isolated step-down current regulators for the regulated current magnitude in the series string circuit. The control system can also determine the total magnitude of collected solar photovoltaic current and power delivered to the DC to AC inverters. The control system may also utilize a wireless or fiber optic system for data and control communications between the plurality of distributed devices.

In another aspect the present invention is a method of collecting at least one megawatt of solar photovoltaic electrical power and delivering the collected solar photovoltaic electrical power to an AC transmission network. The at least one megawatt of solar photovoltaic DC electrical power is generated from one or more solar photovoltaic power collectors interconnected to have an output of at least at 1.5 kilovolts. The DC electrical power is transported to the DC inputs of one or more DC to AC inverters. The DC electrical power is converted to AC electrical power in each of the inverters. The AC electrical power is phase shifted from the AC output of each of the DC to AC inverters and injected into the AC transmission network. The output of one or more groups of the solar photovoltaic power collectors may be step-up voltage regulated to the maximum power point for the group. The one or more groups of one or more solar photovoltaic power collectors may be formed into one or more solar photovoltaic power collection nodes. The output of each one of the one or more solar photovoltaic power collection nodes may be step-down current regulated. The outputs of each solar photovoltaic power collection node may be interconnected to form a string series photovoltaic power collection circuit. The transporting of the DC electrical power to the DC input of one or more DC to AC inverters may be accomplished by serially interconnecting the DC inputs of each DC to AC inverter to form a string series input circuit to the inverters and connecting the string series photovoltaic power collection circuit across the string series input circuit to the inverters to form a high voltage DC power loop circuit.

In another aspect the present invention is a method of delivering a megawatt or greater amount of DC electrical power from a high voltage solar photovoltaic electrical power source to an AC transmission network. The megawatt level DC electrical power is generated from one or more solar photovoltaic power collectors interconnected to have an output voltage of at least 1.5 kilovolts and transported to the DC inputs of one or more DC to AC inverters. The megawatt level of DC electrical power is converted to AC electrical power in each DC to AC inverter and the AC electrical current is phase-shift transformed from the AC output of each one of the one or more DC to AC inverters for injection into the AC transmission network. The output of one or more groups of the solar photovoltaic power collectors may be step-up voltage regulated to the maximum power point for the groups. The groups of solar photovoltaic power collectors may be formed into one or more solar photovoltaic power collection nodes. The output of each one of the one or more solar photovoltaic power collection nodes may be step-down current regulated. The outputs of each solar photovoltaic power collection node may be interconnected to form a string series photovoltaic power collection circuit. The transporting of the DC electrical power to the DC input of the DC to AC inverters may be accomplished by serially interconnecting the DC inputs of each DC to AC inverter to form a string series input circuit to the inverters and connecting the string series photovoltaic power collection circuit across the string series input circuit to the inverters to form a high voltage DC power loop circuit.

The above and other aspects of the invention are further set forth in this specification and the appended claims.

### BRIEF DESCRIPTION OF THE DRAWINGS

The appended drawings, as briefly summarized below, are provided for exemplary understanding of the invention, and do not limit the invention as further set forth in this specification and the appended claims:

FIG. 1 is a simplified diagrammatic representation of one example of a known arrangement of apparatus for solar photovoltaic power collection, conversion and connection to a transmission grid.

FIG. 2 is one example of an arrangement of apparatus of the present invention for solar photovoltaic DC power collection, conversion of the collected DC power to AC power, and supply of the AC power to an AC transmission network or grid.

FIG. 3 illustrates one example of a plurality of solar power collectors forming a solar power collection node used in one example of the present invention.

FIG. 4 is one example of a physical arrangement of a solar power collector used in the present invention.

FIG. 5 is a simplified electrical schematic of one example of a solar power collector of the present invention.

FIG. 6 is a simplified schematic of one example of a step-up voltage regulator used with a series array of solar photovoltaic modules making up a solar power collector used in the present invention.

FIG. 7 is a simplified schematic of one example of a solar power collection node-isolated step-down current regulator used in the present invention.

FIG. 8 illustrates waveforms relevant to the operation of the node-isolated step-down current regulator schematically represented in FIG. 7.

FIG. 9 illustrates waveforms relevant to the operation of the step-up voltage regulator schematically represented in FIG. 6.

FIG. 10 is a simplified schematic representation of one example of a type of regulated current source inverter used in some examples of the present invention.

FIG. 11 illustrates waveforms relevant to the operation of the regulated current source inverter schematically represented in FIG. 10.

FIG. 12(a) through FIG. 12(c) illustrate three non-limiting examples of phase shifting transformation networks that may be used in the present invention.

FIG. 13 illustrates a typical AC output from the primary windings of the phase shifting transformation network shown in FIG. 12(a).

FIG. 14 illustrates a plurality of solar power collectors forming a solar power collection node used in one example of the invention.

FIG. 15 is a simplified electrical schematic of a solar power collector used in one example of the invention.

FIG. 16 is an arrangement of apparatus used in one example of the present invention for solar photovoltaic DC power collection, conversion of the collected DC power to AC power, and supply of AC power to an AC electric transmission network.

FIG. 17 is an arrangement of apparatus used in another example of the present invention for solar photovoltaic DC power collection, conversion of the collected DC power to AC power, and supply of AC power to an AC electric transmission network.

FIG. 18 is an arrangement of apparatus used in another example of the present invention for solar photovoltaic DC power collection, conversion of the collected DC power to AC power and supply of AC power to an AC electric transmission network.

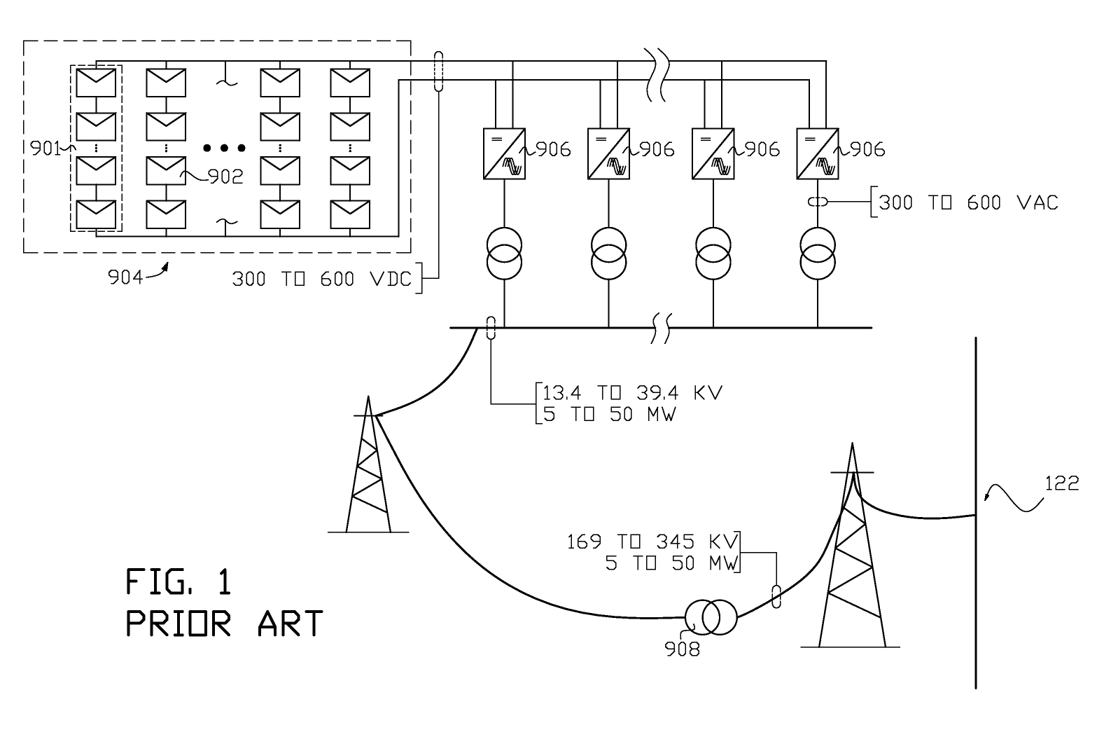

### DETAILED DESCRIPTION OF THE INVENTION

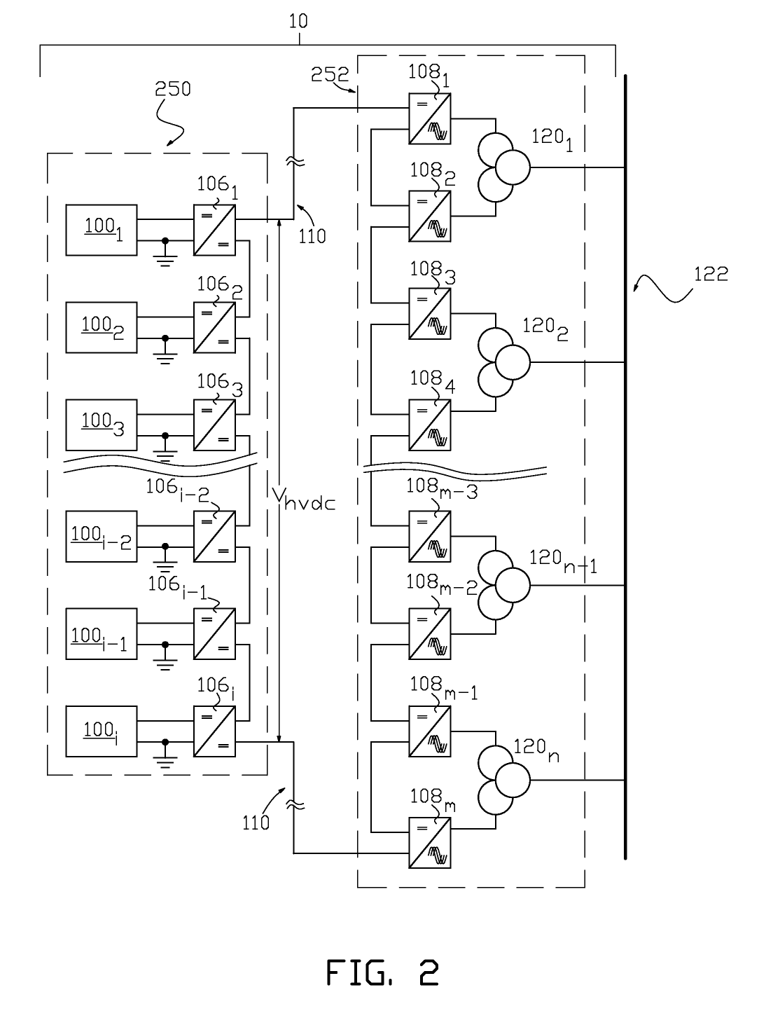

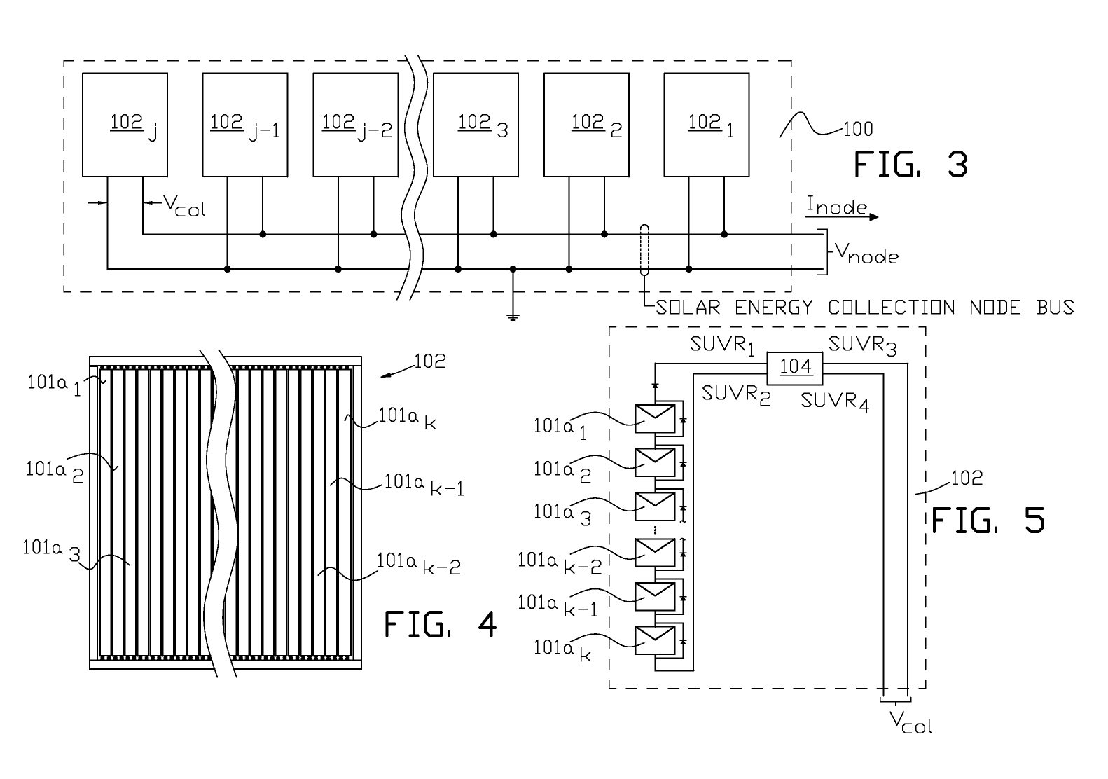

FIG. 2 illustrates one example of an arrangement of apparatus 10 of the present invention for solar photovoltaic DC power collection, conversion to AC power, and supply of the AC power to a transmission network. Solar power collection nodes 100₁ through 100ᵢ are each connected to a respective node-isolated step-down current regulator 106₁ through 106ᵢ, where “i” is a positive integer. Each solar power collection node (generally referred to by reference number 100) comprises a plurality of solar PV power collectors 102₁ through 102ⱼ having their DC outputs, V_{col}, connected together in parallel as shown in FIG. 3. The variable “j” may be any positive integer, and can be a different integer value for the plurality of solar PV power collectors in each distinct solar power collection node 100. A typical solar PV power collector (generally referred to by reference number 102) is illustrated in non-limiting physical and electrical schematic form in FIG. 4 and FIG. 5 respectively. Referring to FIG. 5, in this particular non-limiting example of the invention, each solar PV power collector 102 comprises an array of serially connected solar photovoltaic modules 101a₁ through 101aₖ that has its array output connected to collector step-up voltage regulator 104. The variable “k” may be any positive integer, and can be a different integer value for the plurality of solar photovoltaic modules in each distinct solar PV power collector 102. Consequently the DC output voltage, V_{node}, of each solar power collection node (and each solar power collector 102), is held relatively constant while the DC output current, I_{node}, of each solar power collection node and solar PV power collector varies in accordance with the instantaneous “maximum power point” or “MPP” for each solar PV power collector (102₁ through 102ⱼ) making up a solar power collection node. The MPP is defined as the point at which a solar cell can deliver maximum electrical power (maximum voltage multiplied by current) for a given irradiation level and electrical load applied to the solar cell. Without output voltage equalization for each solar PV power collector making up a solar power collection node, the instantaneous DC output voltage, V_{col}, of a collector 102 may vary over a range (for example, between 1.08 kV and 2.16 kV) depending upon the instantaneous incident level of illumination (irradiation) on the solar cells making up the solar PV power collectors 102 in a solar power collection node. The term “photovoltaic module” is used herein in the broadest sense to define one or more solar cells contained in any type of enclosure such as, but not limited to, what is commonly known as a photovoltaic module.

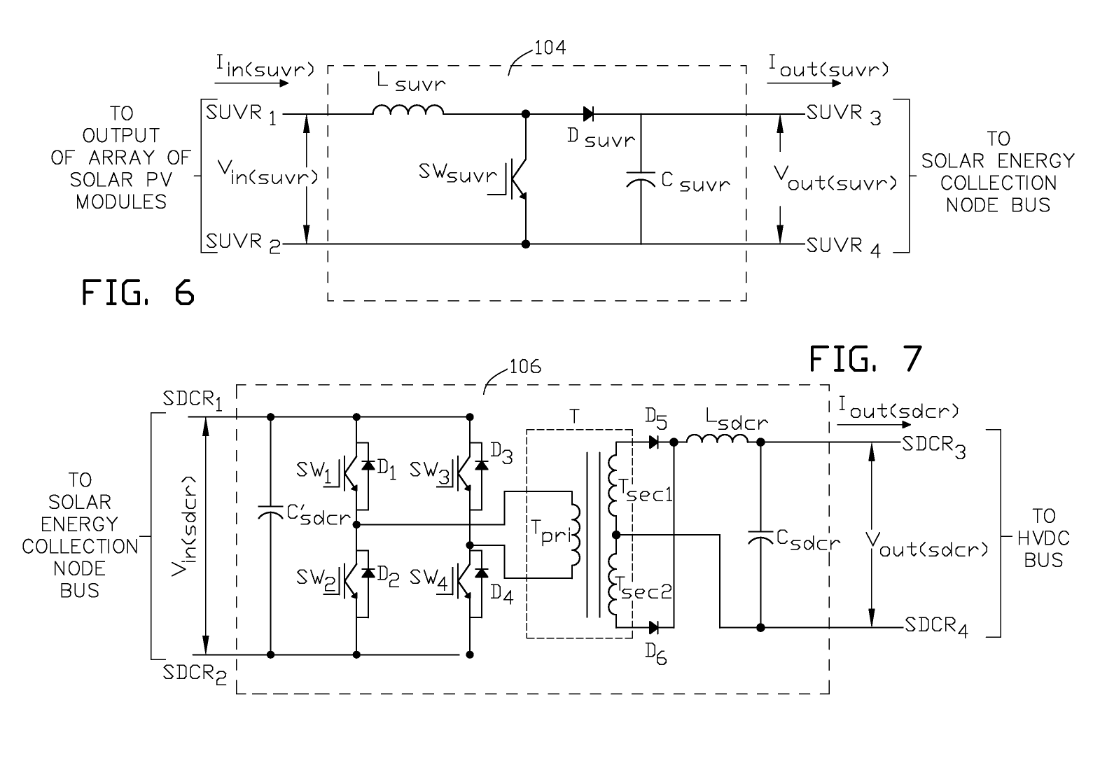

One typical, non-limiting scheme for implementing step-up voltage regulation in a solar PV power collector is the step-up voltage regulator (SUVR) 104 shown in FIG. 6. Input terminals SUVR₁ and SUVR₂ are connected across the output of the series array of solar PV modules making up a solar PV power collector. Switching device SWₛᵤᵥᵣ periodically connects inductive energy storage device Lₛᵤᵥᵣ across the output of the series array of PV modules. Energy storage device Lₛᵤᵥᵣ (such as an inductor) stores energy that is transferred to capacitive energy storage device Cₛᵤᵥᵣ (such as a capacitor) via diode Dₛᵤᵥᵣ. The relationship between the output voltage, Vₒᵤₜ₍ₛᵤᵥᵣ₎, and input voltage, Vᵢₙ₍ₛᵤᵥᵣ₎, of the SUVR is defined by the following equation:

$${V}_{out ( suvr )} = \frac{1}{Δ} \cdot {V}_{i n ( suvr )} , \qquad [ equation ( 1 ) ]$$

where Δ is defined as the duty cycle of the SUVR in the following equation:

$$Δ = \frac{{T}_{period} - {T}_{charge}}{{T}_{period}} , \qquad [ equation ( 2 ) ]$$

where T_{charge} is equal to the period of time for storing energy in the inductive energy storage device, Lₛᵤᵥᵣ, and T_{period} is equal to the time period of repetition of the charging cycles. The relationship between output current, Iₒᵤₜ₍ₛᵤᵥᵣ₎, and input current, Iᵢₙ₍ₛᵤᵥᵣ₎, of the step-up voltage regulator is defined by the following equation:

Iₒᵤₜ₍ₛᵤᵥᵣ₎=Iᵢₙ₍ₛᵤᵥᵣ₎·Δ [equation (3)],

and the relationship between output power, Pₒᵤₜ₍ₛᵤᵥᵣ₎ and input power, Pᵢₙ₍ₛᵤᵥᵣ₎ of the step-up voltage regulator can be defined by the following equations:

Pₒᵤₜ₍ₛᵤᵥᵣ₎=(Iₒᵤₜ₍ₛᵤᵥᵣ₎·Vₒᵤₜ₍ₛᵤᵥᵣ₎)=Pᵢₙ₍ₛᵤᵥᵣ₎=(Iᵢₙ₍ₛᵤᵥᵣ₎·Vᵢₙ₍ₛᵤᵥᵣ₎) [equation (4)]

The waveforms in FIG. 9 illustrate various features of the SUVR simplified schematic shown in FIG. 6. In FIG. 9 each regulation time period (T_{reg}), is a multiple of one-sixth of the line voltage time period of the grid 122, to minimize the ripple effect on the output currents of inverters 108; that is, the regulation time period can be ⅙^{th}, 1/12^{th}, 18^{th} . . . of the grid's line voltage time period, which is 167 milliseconds for a nominal 60 Hertz grid, or 200 millisecond for a nominal 50 Hertz grid. During each regulation period (T_{reg}) switch SWₛᵤᵥᵣ is closed for a “charge” time period (T_{charge}), and open for the remainder of the regulation period as illustrated by waveform 302 in FIG. 9. When switch SWₛᵤᵥᵣ is closed, inductor Lₛᵤᵥᵣ stores energy supplied by an increasing DC current as illustrated by the regions of waveform 304 with a positive slope. When switch Sₛᵤᵥᵣ is open, stored energy in inductor Lₛᵤᵥᵣ flows to capacitor Cₛᵤᵥᵣ, as illustrated by regions of waveform 304 with a negative slope, to store charge energy in the capacitor. This arrangement allows inductor Lₛᵤᵥᵣ to charge capacitor Cₛᵤᵥᵣ to a voltage level greater than the instantaneous SUVR input DC voltage level, and allows continuous operation of the SUVR, as defined by the MPP, when the instantaneous SUVR input DC voltage level, Vᵢₙ₍ₛᵤᵥᵣ₎, is below the operating DC voltage input to inverters 108 as required to inject AC current onto grid 122. The current supplied at the output of the SUVR is controlled by the duty cycle ratio of switch SWₛᵤᵥᵣ closed time period (T_{charge}) to the switch SWₛᵤᵥᵣ open time period or, in other words, by the amount of energy stored in, and discharged from, inductor Lₛᵤᵥᵣ.

The SUVR circuit shown in FIG. 6 is one non-limiting example of a circuit that can be used as a SUVR in the present invention to perform the function of a step-up voltage regulator as described above.

Therefore step-up voltage regulator 104 converts an unstable DC voltage source comprising an array of solar PV modules into a stable DC voltage source operating at the MPP. The duty cycle of a SUVR can periodically be adjusted in each regulation period for each solar energy collector to achieve maximum Pₒᵤₜ₍ₛᵤᵥᵣ₎, which is equal to the sum of the power levels at the MPP for the solar cells in the solar power collector.

As shown in FIG. 2 the output of each solar power collection node is connected to a respective node-isolated step-down current regulator 106₁ through 106ᵢ. The outputs of all step-down current regulators are connected in a series array to provide a higher DC voltage level that is fed into the inputs of the series of regulated current source inverters 108₁ through 108ₘ, (generally referred to by reference number 108), where “m” is an even integer equal to two or larger in this non-limiting example of the invention. The output of each step-down current regulator is electrically isolated from its input to allow each solar power collection node 100 to be connected (referenced) to electrical ground potential, for example as shown in FIG. 2, while the output of each step-down current regulator 106 in the series of current regulators is referenced to the summed output voltages of all preceding current regulators in the series. For example the output voltage of current regulator 106₃ is added to the sum of the output voltages of current regulators 106₁ and 106₂. Since the outputs of the series of step-down current regulators are connected in series, the output string current of all the regulators will be equal.

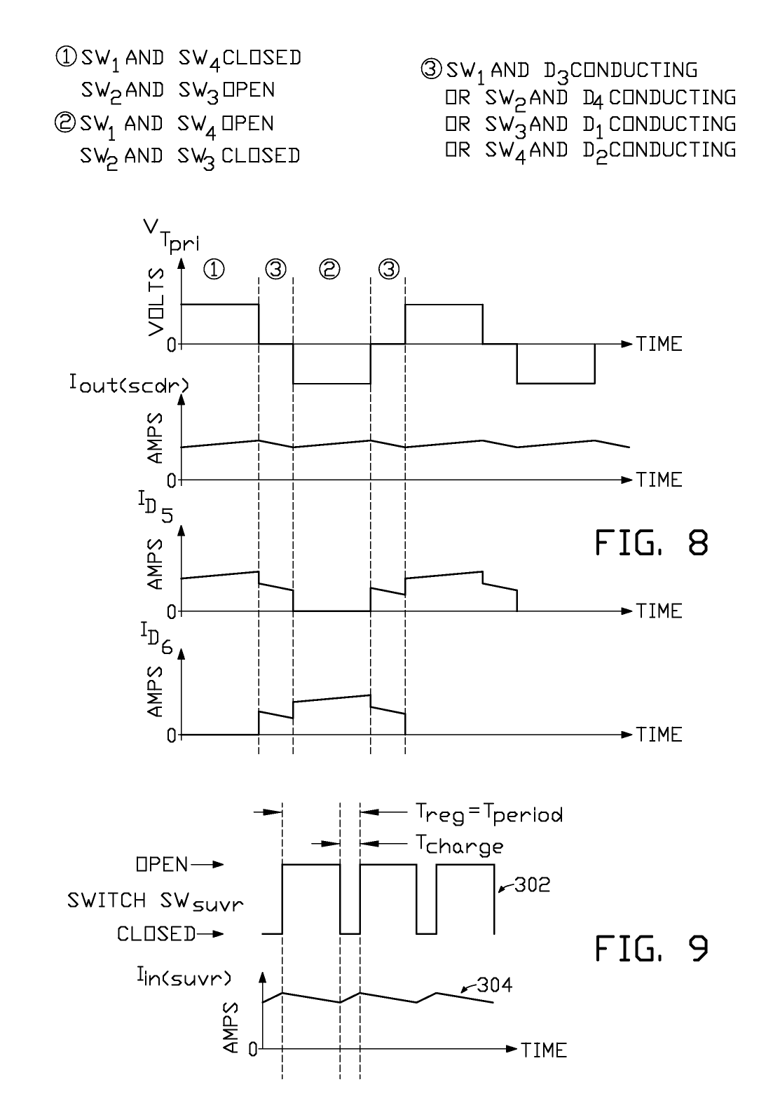

One typical, non-limiting scheme for implementing step-down current regulation in the node-isolated step-down current regulator 106 is illustrated in FIG. 7. Input terminals SDCR₁ and SDCR₂ are connected across the output of a solar power collection node 100. Switching devices SW₁ through SW₄, with respective anti-parallel diodes D₁ through D₄, form a full wave bridge inverter that periodically connects, in an alternating pattern, the primary winding, Tₚᵣᵢ, of transformer T to the input terminals of the SDCR. When switching device pair SW₁ and SW₄ conduct, the voltage across the primary winding of transformer T is positive causing diode D₅ to conduct, and establish a current (I_{out(sdcr)}) flow path from the electrically isolated output SDCR₄ of the step-down current regulator through transformer secondary winding T_{sec1}, diode D₅, and inductive energy storage device L_{sdcr} to the electrically isolated output SDCR₃. When switching device pair SW₂ and SW₃ conduct, the voltage across the primary winding of transformer T is negative causing diode D₆ to conduct, and establish a current flow path from the electrically isolated output SDCR₄ of the step-down current regulator through transformer secondary winding T_{sec2}, diode D₆, and inductive energy storage device L_{sdcr} to the electrically isolated output SDCR₃ of the step-down current regulator. When either switching device SW₁ or SW₂ is not conducting, the voltage across primary winding Tₚᵣᵢ is zero, and both D₅ and D₆ share current and establish a current flow path from the electrically isolated output SDCR₄ of the step-down current regulator through both transformer secondary windings T_{sec1} and T_{sec2}, diodes D₅ and D₆, and inductive energy storage device L_{sdcr} to the electrically isolated output SDCR₃. The waveforms in FIG. 8 illustrate various features of the SDCR shown in FIG. 7. The regulation period for an SDCR is preferably the same as that for the SUVR as described above.

The SDCR circuit shown in FIG. 7 is one non-limiting example of a circuit that can be used as a SDCR to perform the function of a step-down current regulator as described above.

The DC output current I_{out(sdcr)} as shown in FIG. 8 of each node-isolated step-down current regulator 106 is held relatively constant in magnitude that is equal to the common string current, while the DC output voltage V_{out(sdcr)} varies in accordance with the power input to a step-down current regulator. All step-down current regulators 106₁ through 106ᵢ have their outputs connected together in series as shown in FIG. 2, and supply DC power to the inputs of regulated current source inverters (RCSI) 108₁ through 108ₘ, with all of the RCSI inputs connected together in series via high voltage DC transmission link 110. HVDC transmission link 110 may comprise any combination of overhead lines (shielded or unshielded), underground cables and/or submarine cables. HVDC transmission lines can cover significantly greater distances than comparable AC transmission lines since HVDC transmission line losses per unit length are reduced to about two-thirds of a comparable AC system. Factors including reduced line losses, reduced conductor sizing, reduced right-of-way and tower sizing economically favor HVDC overhead lines over comparable AC lines for distances generally greater than 500 kilometers, and HVDC cables for distances greater than 50 kilometers.

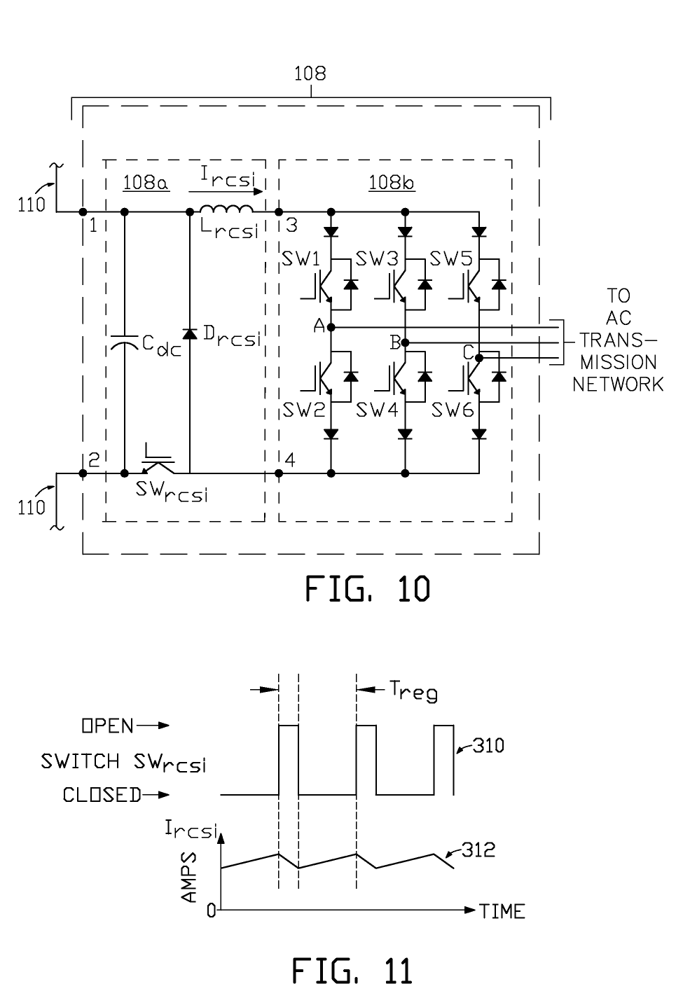

A typical schematic for each RCSI used in this non-limiting example of the invention is shown in FIG. 10. Each RCSI comprises step-down current regulator 108a and inverter 108b. Step-down current regulator 108a serves as a step-down current regulator when the voltage inputted to an RCSI (at points 1 and 2) rises significantly above the operating DC voltage for the RCSI to output current for injection into the grid. The waveforms in FIG. 11 illustrate various features of the RCSI shown in FIG. 10. During each regulation time period, T_{reg}, switch SWᵣₑₛᵢ in FIG. 11 is closed for a “store energy” time period and open for the remainder of the regulation time period as illustrated by waveform 310 in FIG. 11. When switch SWᵣₑₛᵢ is closed, inductor Lᵣₑₛᵢ stores energy supplied by an increasing dc current as illustrated by the regions of waveform 312 having a positive slope. When switch SWᵣₑₛᵢ is open, stored energy in inductor Rᵣₑₛᵢ flows through flywheel diode Dᵣₑₛᵢ to control the average magnitude of DC current supplied to the input of inverter 108b.

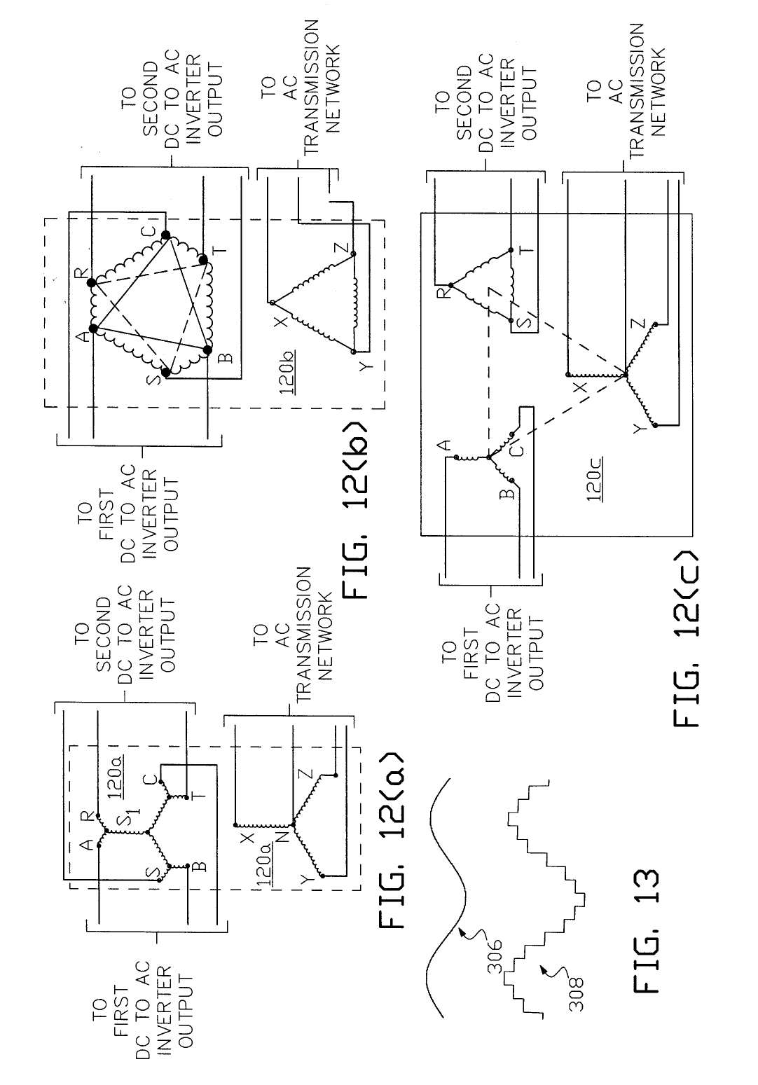

In this non-limiting example of the invention, the outputs of a pair of the three-phase, AC regulated current source inverters 108 are connected to a six-phase-to-three-phase transformation network 120₁ through 120ₙ, where “n” is equal to one-half of the total quantity (“m”) of regulated current source inverters. The three phase AC outputs from each transformation network 120 are suitably connected in parallel to AC grid 122. With reference to the transformation network, the term “primary” is used to refer to the windings of a transformer that are connected to the power grid, and the term “secondary” is used to refer to the windings of a transformer that are connected to the outputs of the regulated current source inverters used in the particular example of the invention. Three examples of six-phase-to-three phase (phase shifting) transformation networks suitable for the present invention are respectively represented in FIG. 12(a), FIG. 12(b) and FIG. 12(c) as transformation networks 120a, 120b and 120c. Utilization of such phase shifting transformation networks results in a stepped three phase current output from the primary windings of the transformer for injection into grid 122, which controls the harmonic content of the current injected into the grid. For example waveforms 306 and 308 in FIG. 13 are representative of the output voltage and current, respectively, from the primary windings of transformation network 120a shown in FIG. 12(a). Reference is made to U.S. patent application Ser. No. 12/325,187, which is incorporated herein by reference in its entirety, for other arrangements of regulated current source inverters and transformation networks that may be utilized in other examples of the present invention.

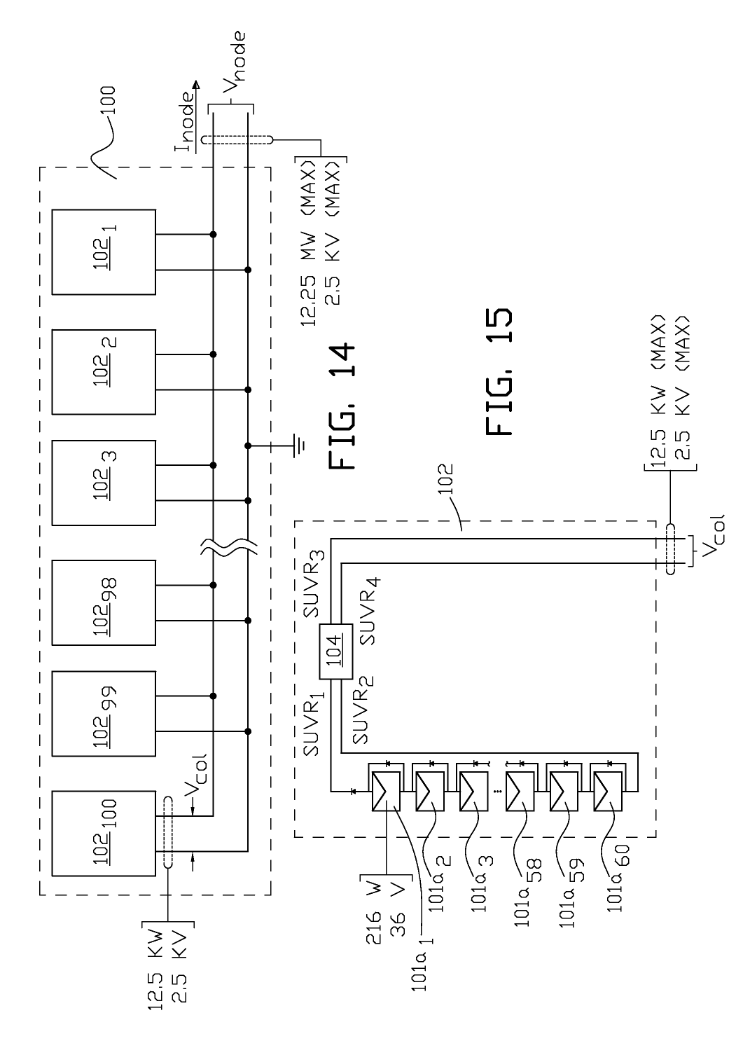

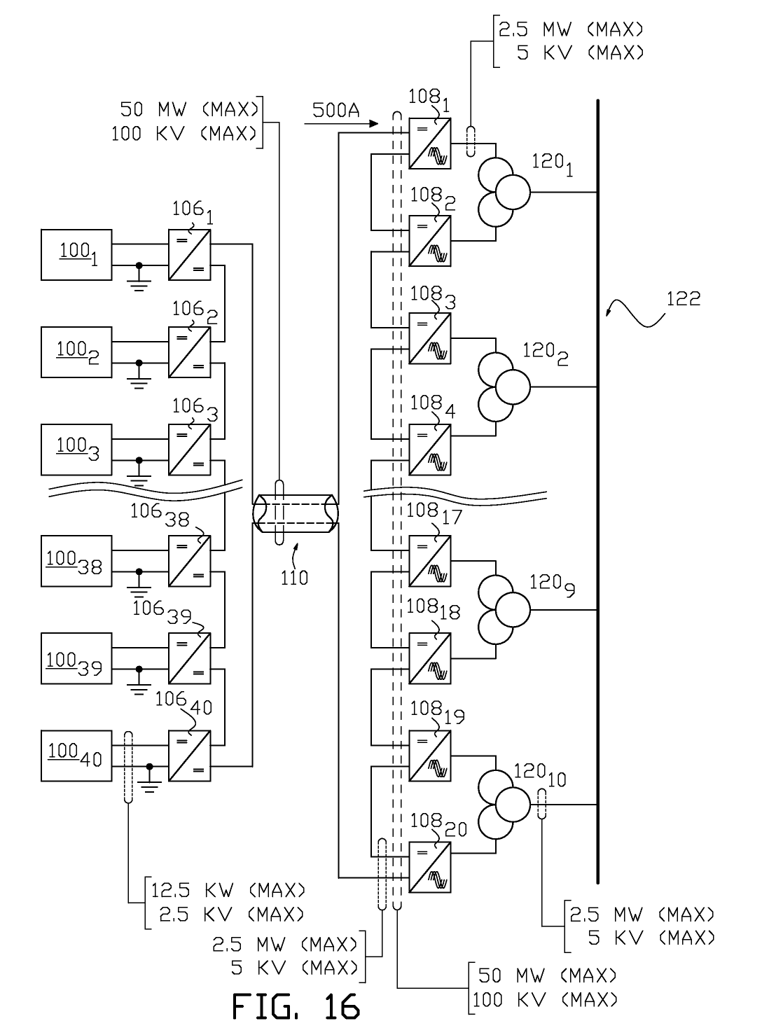

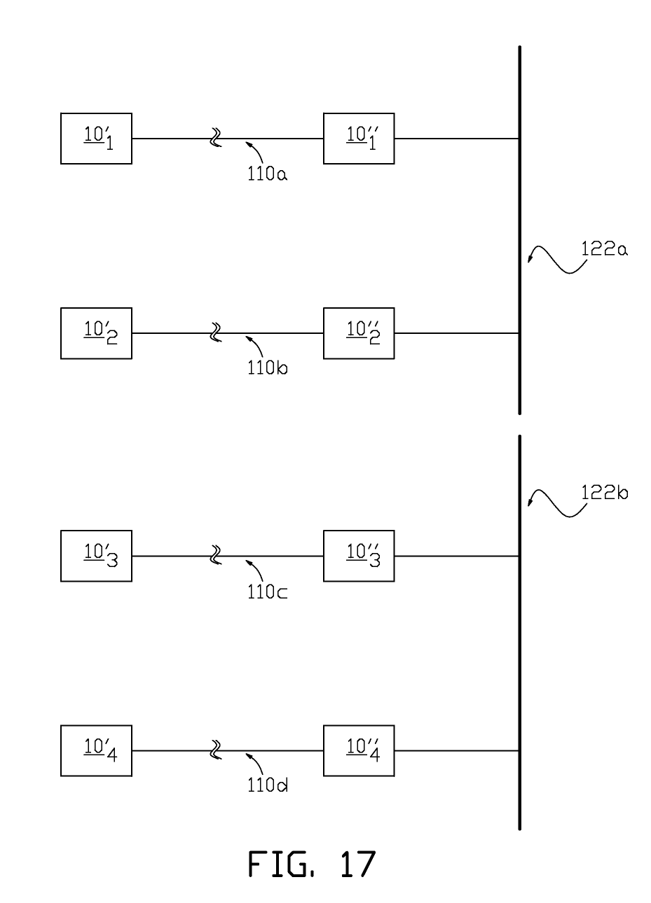

FIG. 14, FIG. 15 and FIG. 16 illustrate one non-limiting example of the present invention. In FIG. 15 each solar PV module, for example module 101a₁, comprises an assembly of solar cells electrically arranged to convert photovoltaic solar power into DC power preferably within the range of about 216 watts (W) at 36 volts DC; this rating can be achieved, for example, from a series connection of approximately 60 solar cells in each solar PV module 101, with each cell producing about 6 amperes at 0.6 volts DC when operating at the MPP. Each solar PV power collector 102 may comprise around 60 solar PV modules in this example. In FIG. 14, 100 solar power collectors (100₁ through 100₁₀₀) have their outputs connected together in parallel to form a solar collection node 100. The duty cycle, Δ, of SUVR 104 is varied, for example, as described above, so that each solar PV power collector operates at the MPP and each solar power collector produces around 12.5 kilowatts of power. The preferred equalized DC output voltage of each solar power collector for this example is approximately 2.5 kilovolts. More generally, in the present invention, each solar power collector functioning as a high voltage DC source of solar photovoltaic power will have a DC source output voltage of at least 1.5 kilovolts. Therefore the output of a solar power collection node in this example can deliver up to about a maximum of 12.5 megawatts at 2.5 kilovolts DC. However the instantaneous output current of each collection node can fluctuate, for example between about 10 and 500 amperes, depending on the magnitude of incident illumination (irradiation level) on the solar cells making up the solar PV modules in the solar power collectors, which in turn, comprise a solar collection node. One or more of the solar PV power collectors may optionally be mounted on suitable tracker apparatus, for example, dual axis tracker apparatus to increase the annual amount of generated DC power by approximately 36 percent over that achievable with a fixed mount solar PV power collector. Referring to FIG. 16 there are 40 solar power collection nodes in this example. At rated maximum output, these 40 solar power collection nodes 100 will generate a total of 50 megawatts of power at 100 kilovolts DC. Therefore, in this example, HVDC transmission links 110 should be rated at 500 amperes. During periods of minimal incident illumination on the solar cells in the solar power collection nodes, caused for example by sun shading by clouds, power can drop to approximately 1 megawatt at 80 kilovolts for a current of 12.5 amperes.

As illustrated in FIG. 17 multiple solar PV power collection sites, 10′₁ through 10′₄, where each site, for example site 10′₁, represents solar power collection site 250 comprising solar power collection nodes 100₁ through 100ᵢ and node-isolated step-down current regulators 106₁ through 106ᵢ in FIG. 2, can be respectively connected via HVDC transmission links 110a through 110d to power conversion stations 10″₁ through 10″₄, where each station, for example station 10″₁ represents power conversion station 252 comprising regulated current source inverters 108₁ through 108ₘ and phase shifting transformation networks 120₁ through 120ₙ in FIG. 2 for connection to AC grids 122a and 122b, which may, or may not, be interconnected. As in other examples of the invention, since transmission links 110a through 110d are high voltage DC links, each multiple solar photovoltaic collection site (10′₁ through 10′₄) may be located at significant distances from their respective power conversion stations and AC grid tie-ins.

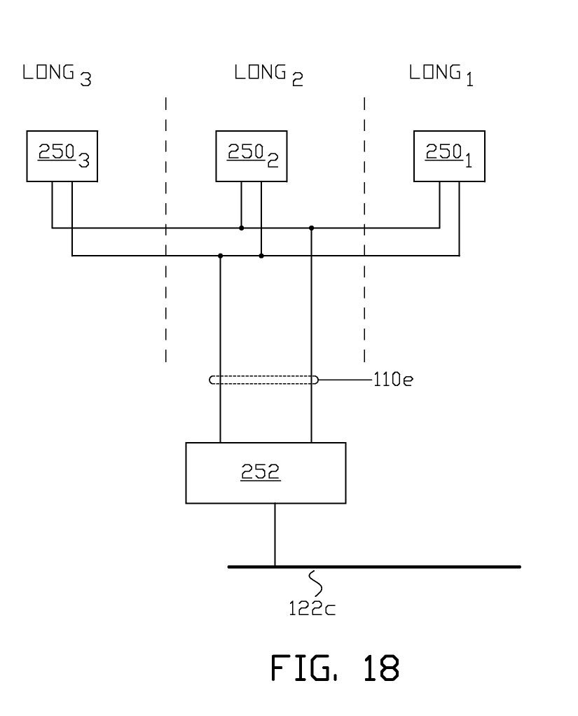

A particular advantage of the present invention is that solar photovoltaic power may be collected from a plurality of geographic regions that can extend over a large longitudinal distance so that the period of daily collection of solar photovoltaic power into an AC grid (or interconnected AC grids) can be maximized as the Earth rotates and the sunlit region progresses across the longitude. For example as shown in FIG. 18, a plurality of solar PV power collection sites, 250₁ through 250₃, each representing multiple groupings of solar power collection nodes and associated node-isolated step-down current regulator, may be physically located at three different locations LONG₁, LONG₂ and LONG₃ along the Earth's longitude with HVDC transmission link 110e interconnecting the three solar collection sites to conversion station 252, which can comprise two or more step-down regulated current source inverters and transformation networks for connection to grid 122c. The string current in each solar power collection site may be regulated to achieve equal voltage output from each site to allow parallel connection of sites. This extended physical range of a solar farm of the present invention is achievable utilizing the combination of high voltage solar power collectors with DC output voltage stabilization for the solar power collectors; collection node-isolated step-down current regulation; and HVDC transmission to a single DC-to-AC power conversion location.

A distributed monitoring and control system can be provided, for example, to set the duty cycles of all step-up voltage regulators and step-down current regulators, as described above, to achieve the MPP for each solar PV power collector, and a regulated level of string current in each current collection node. For multiple PV power collection sites, equal voltage monitoring and control from each site can be implemented by one or more (redundant) suitable communication links, such as a wireless link, a wired link (for example, fiber optic lines) or carrier data signals on the HVDC transmission links. System parameters, such as total magnitude of collected DC power can be transmitted as inputs to the control circuitry for the plurality of regulated current source inverters.

Although regulated current source inverters are used in the above examples of the invention, other types of inventors may also be used. Although the AC outputs of two DC to AC inverters feed a single transformation network, other arrangements can be used in other examples of the invention. For example there may be one, or any number of inverters feeding a single transformation network to provide stepped three phase AC power to the grid.

The above examples of the invention have been provided merely for the purpose of explanation, and are in no way to be construed as limiting of the present invention. While the invention has been described with reference to various embodiments, the words used herein are words of description and illustration, rather than words of limitations. Although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto, and changes may be made without departing from the scope of the invention in its aspects.

1. Apparatus for collecting at least one megawatt of solar photovoltaic power and delivering the at least one megawatt of solar photovoltaic power to an AC transmission network, the apparatus comprising:
at least one high voltage DC source for generating the at least one megawatt of solar photovoltaic power, the at least one DC source having a high voltage DC source output voltage rating of at least 1.5 kilovolts;
a high voltage DC power transmission link connected to the high voltage DC source output of the at least one DC source; and
at least one DC to AC inverter having an inverter DC input connected to the high voltage DC source output of the at least one DC source via the high voltage DC power transmission link and an inverter AC output for injection of the at least one megawatt of solar photovoltaic power into the AC transmission network.

2. The apparatus of claim 1 wherein the at least one high voltage DC source comprises one or more nodes of solar photovoltaic power collectors, each of the one or more nodes having an output connected to the input of a dedicated node isolated step-down current regulator, the outputs of all the dedicated node isolated step-down current regulators serially interconnected to form a serial string DC current circuit.

3. The apparatus of claim 2 wherein the solar photovoltaic power collectors for each one of the one or more nodes are arranged in one or more groups of solar photovoltaic power collectors, each one of the one or more groups of solar photovoltaic power collectors has a group output interconnected in parallel to the output of the dedicated node isolated step-down current regulator.

4. The apparatus of claim 3 wherein each of the one or more groups of solar photovoltaic power collectors comprises a plurality of solar photovoltaic modules interconnected in a series string circuit connected to the input of a step-up voltage regulator.

5 The apparatus of claim 1 wherein the at least one DC to AC inverter comprises at least one regulated current source grid synchronized inverter where the inverter AC output has a three phase substantially stepped current waveform.

6. The apparatus of claim 1 wherein the at least one DC to AC inverter comprises a plurality of regulated current source grid synchronized inverters, the inverter DC inputs of the plurality of regulated current source grid synchronized inverters serially interconnected to form an inverter input series string circuit connected to the high voltage DC power transmission link, and where the inverter AC output of each of the plurality of the regulated current source grid synchronized inverters has a three phase substantially stepped current waveform.

7. The apparatus of claim 6 wherein the inverter AC output of each of the plurality of regulated current source grid synchronized inverters is connected to the AC transmission network via a phase shifting transformation network.

8. The apparatus of claim 7 wherein the phase shifting transformation network comprises one or more transformers, each of the one or more transformers having multiple secondary phase shifting windings connected to the inverter AC outputs of one or more of the plurality of regulated current source grid synchronized inverters, and multiple primary phase shifting windings connect to the AC transmission network.

9. The apparatus of claim 1 wherein the at least one high voltage DC source comprises one or more nodes of solar photovoltaic power collectors, each of the one or more nodes having an output connected to the input of a dedicated node isolated step-down current regulator having a current regulation duty cycle, the outputs of all the dedicated node isolated step-down current regulators serially interconnected to form a serial string DC current circuit, and the solar photovoltaic power collectors for each one of the one or more nodes are arranged in one or more groups of solar photovoltaic power collectors, each one of the one or more groups of solar photovoltaic power collectors has a group output interconnected in parallel to the output of the dedicated node isolated step-down current regulator, each of the one or more groups of solar photovoltaic power collectors comprises a plurality of solar photovoltaic modules interconnected in a series string circuit connected to the input of a step-up voltage regulator having a voltage regulation duty cycle, the apparatus further comprising:
a plurality of distributed devices comprising a control system for determining and setting the voltage regulation duty cycle for each one of the step-up voltage regulators for the maximum power point of each one of the groups of solar voltaic power collectors, for determining and setting the current regulation duty cycle for each one of the dedicated node isolated step-down current regulators for the regulated current magnitude in the series string circuit, and for determining the total magnitude of collected solar photovoltaic current and power delivered to the at least one DC to AC inverter; and
a wireless system for data and control communications between the plurality of distributed devices.

10. A method of collecting at least one megawatt of solar photovoltaic electrical power and delivering the collected solar photovoltaic electrical power to an AC transmission network, the method comprising the steps of:
generating the at least one megawatt power of solar photovoltaic DC electrical power from one or more solar photovoltaic energy collectors interconnected to have an output of at least at 1.5 kilovolts;
transporting the DC electrical power to the DC inputs of one or more DC to AC inverters;
converting the DC electrical power to AC electrical power in each of the one or more inverters; and
injecting the AC electrical current into the AC transmission network.

11. The method of claim 10 further comprising the step of step-up voltage regulating the output of one or more groups of the one or more solar photovoltaic power collectors to maximum power point for the one or more groups.

12. The method of claim 11 further comprising the step of forming one or more solar photovoltaic power collection nodes from the one or more groups of one or more solar photovoltaic power collectors.

13. The method of claim 12 further comprising the step of step-down current regulating the output of each one of the one or more solar photovoltaic power collection nodes.

14. The method of claim 13 further comprising the step of interconnecting the outputs of each one of the one or more solar photovoltaic power collection nodes to form a string series photovoltaic power collection circuit.

15. The method of claim 14 wherein the step of transporting the DC electrical power to the DC input of one or more DC to AC inverters further comprises the steps of serially interconnecting the DC inputs of each one of the one or more DC to AC inverters to form a string series inverters input circuit, and connecting the string series photovoltaic power collection circuit across the string series inverters input circuit to form a high voltage DC power loop circuit.

16. A method of delivering a megawatt level of DC electrical power from a high voltage solar photovoltaic electrical power source to an AC transmission network, the method comprising the steps of:
generating the of DC electrical power from one or more solar photovoltaic power collectors interconnected to have an output of at least at 1.5 kilovolts;
transporting the of DC electrical power to the DC inputs of one or more DC to AC inverters;
converting the of DC electrical power to AC electrical power in each of the one or more DC to AC inverters;
phase-shift transforming the AC electrical current from the AC output of each one of the one or more DC to AC inverters; and
injecting the phase-shifted AC electrical current into the AC transmission network.

17. The method of claim 16 further comprising the step of step-up voltage regulating the output of one or more groups of the one or more solar photovoltaic power collectors to maximum power point for the one or more groups.

18. The method of claim 17 further comprising the step of forming one or more solar photovoltaic power collection nodes from the one or more groups of one or more solar photovoltaic power collectors.

19. The method of claim 18 further comprising the step of step-down current regulating the output of each one of the one or more solar photovoltaic power collection nodes.

20. The method of claim 18 further comprising the step of interconnecting the outputs of each one of the one or more solar photovoltaic power collection nodes to form a string series photovoltaic power collection circuit.

21. The method of claim 14 wherein the step of transporting the DC electrical power to the DC input of one or more DC to AC inverters further comprises the steps of serially interconnecting the DC inputs of each one of the one or more DC to AC inverters to form a string series inverters input circuit, and connecting the string series photovoltaic power collection circuit across the string series inverters input circuit to form a high voltage DC power loop circuit.
